(19) United States
(12) Patent Application Publication
(10) Pub. No.: US 2023/0387388 A1
(43) Pub. Date: Nov. 30, 2023

(54) STABLE PROTECTIVE OXIDE COATINGS FOR ANODES IN SOLID-STATE BATTERIES

(71) Applicant: Rivian IP Holdings, LLC, Irvine, CA (US)

(72) Inventors: Rubayyat Mahbub, Palo Alto, CA (US); Muratahan Aykol, San Jose, CA (US); Forrest Gittleson, Mountain View, CA (US)

(21) Appl. No.: 17/752,195

(22) Filed: May 24, 2022

(51) Int. Cl. H01M 4/36; H01M 10/0562; H01M 10/0525

(52) U.S. Cl. CPC H01M 4/366; H01M 10/0562; H01M 10/0525; H01M 2300/008; H01M 2004/027

(57) ABSTRACT

An electrochemical cell includes a solid-state electrolyte; an anode; and a lithium polyanionic oxide; wherein the lithium polyanionic oxide is at least partially deposited on a surface of the anode.

### INTRODUCTION

The present disclosure relates to anodes having a protective coating or interfacial layer between the anode and solid-state electrolyte. In particular, the protective coatings or interfacial layers include polyanionic lithium metal oxides.

### SUMMARY

In one aspect, an electrochemical cell includes a sulfide-based solid-state electrolyte, an anode, and (a) a lithium polyanionic oxide at least partially deposited on a surface of the anode; (b) a lithium polyanionic oxide present in an interfacial layer between the solid-state electrode and the anode; or (c) both (a) and (b). In any such embodiments, the lithium polyanionic oxides are LiAl(Si₂O₅)₂, LiAlSiO₄, Li₃Sc₂(PO₄)₃, LiMgPO₄, or a mixture of any two or more thereof. In some embodiments, the anode is a lithium metal anode.

In another aspect, a solid-state battery includes a lithium polyanionic oxide separating an anode and a sulfide-based solid-state electrolyte. In such embodiments, the lithium polyanionic oxide are LiAl(Si₂O₅)₂, LiAlSiO₄, Li₃Sc₂(PO₄)₃, LiMgPO₄, or a mixture of any two or more thereof. In some embodiments, the anode is a lithium metal anode.

In yet another aspect, an anode coating material includes a lithium polyanionic oxide that has thermodynamic phase stability, chemical stability against sulfide electrolyte, a Li stability score of greater than that of Al₂O₃, stability against moisture and air, a band gap of greater than 1 eV and an ionic conductivity better than binary metal oxide coatings.

In a yet further aspect, a method of coating a lithium polyanionic oxide onto an anode is provided. Such methods may include depositing on the anode material, following anode formation, a layer of lithium polyanionic oxide using the appropriate stoichiometric ratios of the metal and non-metal constituents of the layer via chemical vapor deposition (CVD), physical vapor deposition (PVD), pulsed laser deposition (PLD), emulsion, sol-gel, atomic layer deposition (ALD), sputtering, and/or other deposition techniques.

In other aspects, an electrochemical cell includes a solid-state electrolyte, an anode, and a lithium polyanionic oxide, wherein the lithium polyanionic oxide is at least partially deposited on a surface of the anode. In some embodiments, the lithium polyanionic oxide comprises a band gap energy of greater than 1 eV. In some embodiments, the lithium polyanionic oxide comprises an ionic conductivy of greater than 10⁻⁸ S/cm. In some embodiments, the lithium polyanionic oxide comprises a energy of less than 50 meV/atom greater than the convex hull. In some embodiments, the lithium polyanionic oxide has an E_{Hull} equal to about 0. In some embodiments, the lithium polyanionic oxide is LiAl(Si₂O₅)₂, LiAlSiO₄, Li₃Sc₂(PO₄)₃, LiMgPO₄, Li₂PO₄, or a mixture of any two or more thereof. In some embodiments, the lithium polyanionic oxide is LiAl(Si₂O₅)₂. In some embodiments, the solid-state electrolyte comprises Li₃PS₄, Li₇P₃S₁₁, or Li₂SP₂S₅, or Li₆PS₅Cl. In some embodiments, the cell includes a cathode including an electroactive material comprising a lithium nickel manganese cobalt oxide (LiNMC), a lithium iron phosphate (LFP), or a lithium cobalt oxide (LCO).

In other aspects, a solid-state battery includes a cathode, a solid-state electrolyte, an anode current collector, and a lithium polyanionic oxide, wherein the lithium polyanionic oxide forms an interfacial layer between the anode current collector and the solid state electrolyte. In some embodiments, the lithium polyanionic oxide comprises a band gap energy of greater than 1 eV. In some embodiments, the lithium polyanionic oxide comprises an ionic conductivy of greater than 10⁻⁸ S/cm. In some embodiments, the lithium polyanionic oxide comprises a energy of less than 50 meV/atom greater than the convex hull. In some embodiments, the lithium polyanionic oxide has an E_{Hull} equal to about 0. In some embodiments, the lithium polyanionic oxide is LiAl(Si₂O₅)₂, LiAlSiO₄, Li₃Sc₂(PO₄)₃, LiMgPO₄, Li₂PO₄, or a mixture of any two or more thereof. In some embodiments, the lithium polyanionic oxide is LiAl(Si₂O₅)₂. In some embodiments, the solid-state electrolyte comprises Li₃PS₄, Li₇P₃S₁₁, or Li₂SP₂S₅, or Li₆PS₅Cl. In some embodiments, the cell includes a cathode including an electroactive material comprising a lithium nickel manganese cobalt oxide (LiNMC), a lithium iron phosphate (LFP), or a lithium cobalt oxide (LCO).

In other aspects, a solid-state battery cell, as described herein, or a solid-state battery, as described herein, may be incorporated into a battery pack comprising a plurality of the solid-state battery cells/batteries. Such batteries, battery cells, or battery packs may then be incorporated in a hybrid electric vehicle or electric vehicle as a power source.

### BRIEF DESCRIPTION OF THE DRAWINGS

FIG. 1A is a schematic illustration of a lithium metal oxide interfacial layer between an anode and a solid-state electrolyte.

FIG. 1B is a schematic illustration of a lithium metal oxide interfacial layer between an anode-free design and a solid-state electrolyte.

FIG. 2 is calculated reaction energy profile for a chemical reaction between Li₃PS₄ and Al₂O₃, where the x-axis shows the molar fraction of Al₂O₃(x=0 is 100% Li₃PS₄ and x=1 is 100% Al₂O₃) and the y-axis describes the reaction enthalpy in eV/atom, as illustrated in the examples.

FIG. 3 is calculated reaction energy profile for a chemical reaction between Li₃PS₄ and Li₃N, where the x-axis shows the molar fraction of Li₃N (x=0 is 100% Li₃PS₄ and x=1 is 100% Li₃N) and the y-axis describes the reaction enthalpy in eV/atom, as illustrated in the examples.

FIG. 4 is a schematic illustration of the identification of lithium metal oxide interfacial layer candidates, according to the examples.

FIG. 5 is an illustration of a cross-sectional view of an electric vehicle, according to various embodiments.

FIG. 6 is a depiction of an illustrative battery pack, according to various embodiments.

FIG. 7 is a depiction of an illustrative battery module, according to various embodiments.

FIG. 8 is a depiction of an illustrative battery with an illustrative cross sectional view, according to various embodiments.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

Through incorporation of lithium metal)(Li⁰) anodes in solid-state batteries (SSBs), the energy density of rechargeable batteries may be doubled. However, lithium metal is reactive with many electrolytes, thereby degrading both the anode material and the electrolytes. Polyanionic lithium metal oxides of general formula Li_{w}MₓE_{y}O_{z}, where w, x, y, and z indicate the stoichiometric ratios of the various constituent atoms, have now been found to be good anode coatings to protect against reaction of the lithium metal with sulfide-based solid-state electrolyte materials (e.g., Li₃PS₄ type materials), or the polyanionic lithium metal oxides may be incorporated in interfacial layers between the anode and solid-state electrolytes.

For graphite anodes in conventional lithium-ion batteries, reactivity can be mitigated by a passivation layer that forms in situ from the reaction products. For Li metal anodes, there is sparse evidence for passivation by in situ reactivity. To limit reactivity between metal anodes and electrolytes, coating materials may be deposited on the metal surface prior to cell assembly. Li metal is highly reactive to moisture and air, and by coating the metal it can aid in protecting the metal anode during handling and processing. The coatings typically range from about 1 nanometer (nm) to several micrometers (μm) in thickness. Similar to passivation layers in graphite anodes, the lithium metal coatings should be durable and electronically insulating to block transfer of electrons between anode and electrolyte. Li metal anodes have traditionally have been protected through various methods, including with coatings of Li₃N, ZrO₂, and Al₂O₃. However, it has now been found that many materials currently used in Li metal solid-state batteries as anode coatings (e.g., Li₃N) are reactive with the state-of-art solid sulfide electrolytes (e.g., Li₃PS₄) to form unanticipated reaction products, including electronically conductive phases that facilitate continued transfer of electrons from the anode to the electrolyte. Binary metal oxide coatings, for example Al₂O₃, although stable and widely used, limit the ionic conductivity between the anode and electrolyte layers. Herein are described Li-containing oxide compounds that may form coating materials for anodes in solid-state batteries, particularly where the anode is lithium metal.

In one aspect, an anode coating material is provided that includes a lithium polyanionic oxide having good stability against moisture and air during handling, interface protection capability better than Al₂O₃, and a band gap of greater than 1.0 eV restricting electron conductivity at the anode-electrolyte interface. In some embodiments, the anode is a lithium metal anode. In a further aspect, an anode coating material includes a lithium polyanionic oxide having excellent chemical and electrochemical (oxidation potential above 2.5V) stability with sulfide electrolyte and an ionic conductivity better than metal oxides. As used herein, where voltages are recited, the recited/reported voltage is versus the Li/Li⁺.

Illustrative lithium polyanionic oxides are salts of lithium where the anion is an oxide of more than one metal. Specifically, in some embodiments this may include LiAl(Si₂O₅)₂, LiAlSiO₄, Li₃Sc₂(PO₄)₃, LiMgPO₄, or a mixture of any two or more thereof, that contain a series of tetrahedron anion units of (EO₄)ⁿ⁻ or their derivatives (E_{y}O_{2y+1})ⁿ⁻ where, E=P or Si.

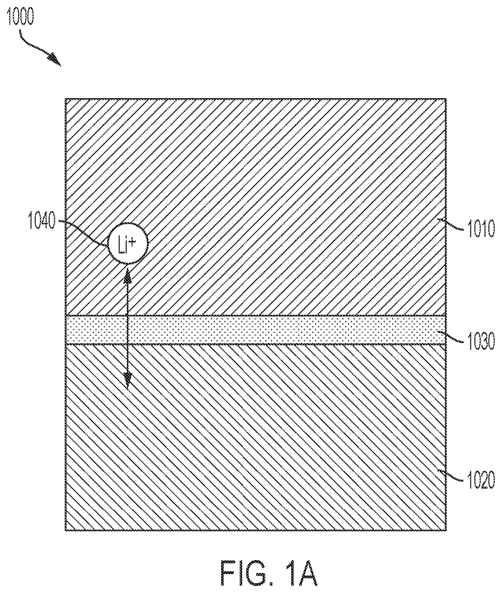

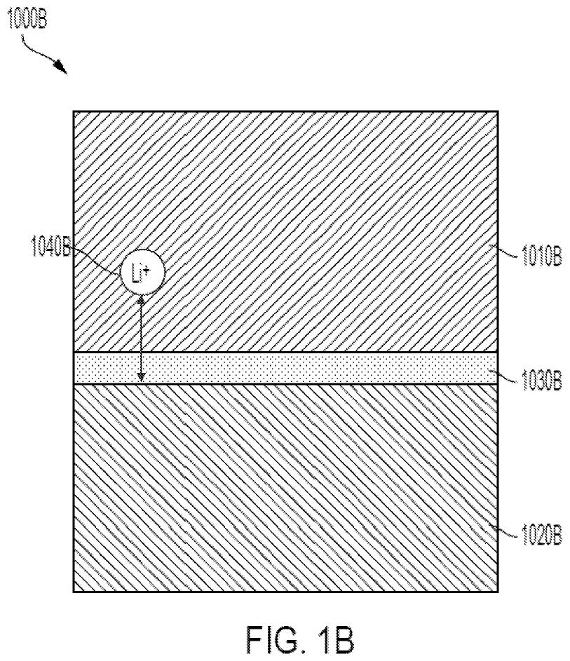

Of course, such materials are for incorporation into electrochemical cells having sulfide-based solid-state electrolytes. Accordingly, in another aspect, an electrochemical cell having a solid-state electrolyte 1010 and an anode 1020 may include a lithium polyanionic oxide 1030 as an interfacial layer between the solid-state electrode 1010 and the anode 1020, and where lithium ions 1040 are transportable through the solid-state electrolyte 1010. See FIG. 1A. The interfacial layer includes a lithium polyanionic oxide that may be at least partially covering the contact surface between the solid-state electrolyte and the anode. The interfacial layer may be formed as a stand-alone layer that is then inserted between the anode and the solid-state electrolyte, or it may be formed as a coating on the anode and/or the solid-state electrolyte prior to electrochemical construction. In yet other embodiments, the anode 1020 may comprise silicon, silicon oxide, carbon, or a composite thereof.

FIG. 1B illustrates an anode-free design, where the a solid-state electrolyte 1010B and an anode current collector 1020B may include a lithium polyanionic oxide 1030B as an interfacial layer between the solid-state electrode 1010B and the anode current collector1020B, and where lithium ions 1040B are transportable through the solid-state electrolyte 1010B to the surface of the anode current collector. See FIG. 1A. Upon discharge of the cell, lithium ions are plated to the current collector through the solid-state electrolyte and/or lithium polyanionic oxide.

Illustrative lithium polyanionic oxides for use in the electrochemical cells include LiAl(Si₂O₅)₂, LiAlSiO₄, Li₃Sc₂(PO₄)₃, LiMgPO₄, Li₃PO₄, or a mixture of any two or more thereof. In any such embodiments, the lithium polyanionic oxide may be LiAl(Si₂O₅)₂.

The solid-state electrolyte that was modeled for determination of the lithium polyanionic oxides for use as the interfacial layer was an electrolyte that includes Li₃PS₄. However, the solid-state electrolyte may be any lithium-containing sulfide based solid-state electrolyte material including, but are not limited to, Li₃PS₄, Li₇P₃S₁₁, or Li₂SP₂S₅, or Li₆PS₅Cl.

The electrochemical cells described herein may also include a cathode comprising a cathode active material such as, but not limited to any of a variety of lithium nickel manganese cobalt oxides (LiNMC materials), lithium iron phosphate (LFP), lithium cobalt oxide (LCO), and the like.

The cathodes may include a cathode active material and one or more of a current collector, a conductive carbon, a binder, and other additives. The electrodes may also contain other materials such as conductive carbon materials, current collectors, binders, and other additives. Illustrative conductive carbon species include graphite, carbon black, Super P carbon black material, Ketjen Black, Acetylene Black, SWCNT, MWCNT, graphite, carbon nanofiber, and/or graphene, graphite. Illustrative binders may include, but are not limited to, polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”) or carboxymethylcellulose (“CMC”). Other illustrative binder materials can include one or more of: agar-agar, alginate, amylose, Arabic gum, carrageenan, caseine, chitosan, cyclodextrines (carbonyl-beta), ethylene propylene diene monomer (EPDM) rubber, gelatine, gellan gum, guar gum, karaya gum, cellulose (natural), pectine, poly(3,4-ethylenedioxythiophene) polystyrene sulfonate (PEDOT-PSS), polyacrilic acid (PAA), poly(methyl acrylate) (PMA), poly(vinyl alcohol) (PVA), poly(vinyl acetate) (PVAc), polyacrylonitrile (PAN), polyisoprene (Plpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or mixtures of any two or more thereof. The current collector may include a metal that is aluminum, copper, nickel, titanium, stainless steel, or carbonaceous materials. In some embodiments, the metal of the current collector is in the form of a metal foil. In some specific embodiments, the current collector is an aluminum (Al) or copper (Cu) foil. In some embodiments, the current collector is a metal alloy, made of Al, Cu, Ni, Fe, Ti, or combination thereof. In another embodiment, the metal foils maybe coated with carbon: e.g., carbon-coated Al foil, and the like.

The anodes of the electrochemical cells may include lithium. In some embodiments, the anodes may also include a current collector, a conductive carbon, a binder, and other additives, as described above with regard to the cathode current collectors, conductive carbon, binders, and other additives. In some embodiments, the electrode may comprise a current collector (e.g., Cu foil) with an in situ-formed anode (e.g., Li metal) on a surface of the current collector facing the separator or solid-state electrolyte such that in an uncharged state, the assembled cell does not comprise an anode active material. For anode-free configuration, Li-ions extracted from the cathode are electrodeposited at the anode current collector during charging. The Li-metal plated “in-situ” is dissolved again and intercalated into the cathode during discharging of the cell. Furthermore, the anodes of electrochemical cells may include silicon active material or silicon-carbon composite electrode active material.

The lithium polyanionic oxide may be present as an interfacial layer and/or as a coating on the surface of the anode or the solid-state electrolyte or both the anode and electrolyte. The lithium polyanionic oxide having may be at least partially covering the contact surface between the solid-state electrolyte and the anode.

Illustrative lithium polyanionic oxides for use in the solid-state batteries include LiAl(Si₂O₅)₂, LiAlSiO₄, Li₃Sc₂(PO₄)₃, LiMgPO₄, Li₃PO₄, or a mixture of any two or more thereof. In any such embodiments, the lithium polyanionic oxide may be LiAl(Si₂O₅)₂.

The cathodes, anodes, carbon materials, binders, etc., as described herein in may form the recited or other components of the battery cell.

In a yet further aspect, methods of coating the lithium polyanionic oxide materials onto the anode are provided. Such methods may include depositing on the anode material, following anode formation, a layer of lithium polyanionic oxides using the appropriate stoichiometric ratios of the metal constituents of the layer via chemical vapor deposition (CVD), physical vapor deposition (PVD), pulsed laser deposition (PLD), emulsion, sol-gel, atomic layer deposition (ALD), and/or other deposition techniques. For example, a lithium polyanionic oxides may be deposited via ALD using precursor materials containing lithium and metal precursors.

The precursors include various materials containing the elements of Li, Al, Mg, Sc, Si, P, or a mixture of any two or more thereof, in the appropriate stoichiometric ratio.

Other methods of formation include solution methods by coating precursors in a solution onto the anode and drying or calcining the anode after coating/application. Illustrative lithium element sources include materials such as, but not limited to, lithium halides, lithium alkoxides (i.e. lithium tert-butoxide), lithium oxides, lithium carbonates, lithium acetate, and lithium hydroxides. Illustrative “metal” sources for the lithium polyanionic oxide include the metals, metal oxides, metal halides, metal nitrides, metal carbonates, metal acetate, and the like. By controlling the ratio of lithium to the metals, lithium polyanionic oxide layers or “films” of a wide variety of stoichiometric compositions may be formed/deposited.

The obtainable thickness for the lithium polyanionic oxide may be dependent on the coating methods and time applied. Depositions using gas phase precursors (e.g., ALD, MLD, sputtering) generally produce thinner coatings with thicknesses ranging from 1 or several nm to hundreds of nm. Methods using solution-phase precursors (e.g., spin, dip, cast, and spray coatings) generate submicron to a few micrometer thick coatings. For example, Li_{w}AlₓSi_{y}O_{z} (LASO) thin films can be deposited by alternating ALD deposition cycles of LiOH, Al₂O₃, and SiO₂ as the sources for Li, Al and Si, respectively. Manipulation of the cation composition and thickness can be achieved through well-controlled surface reactions during each precursor pulse cycle.

Additional methods of coating the lithium polyanionic oxide materials onto the anode are also provided. Such methods may include depositing the lithium polyanionic oxide via any of the above methods onto a release surface such that the deposited layer or “film” may be lifted and applied to the surface of the anode as a standalone film separating the anode from the cathode.

In another aspect, the present disclosure provides a battery pack comprising the cathode active material, the electrochemical cell, or the lithium ion battery of any one of the above embodiments. The battery pack may find a wide variety of applications including but are not limited to general energy storage or in vehicles.

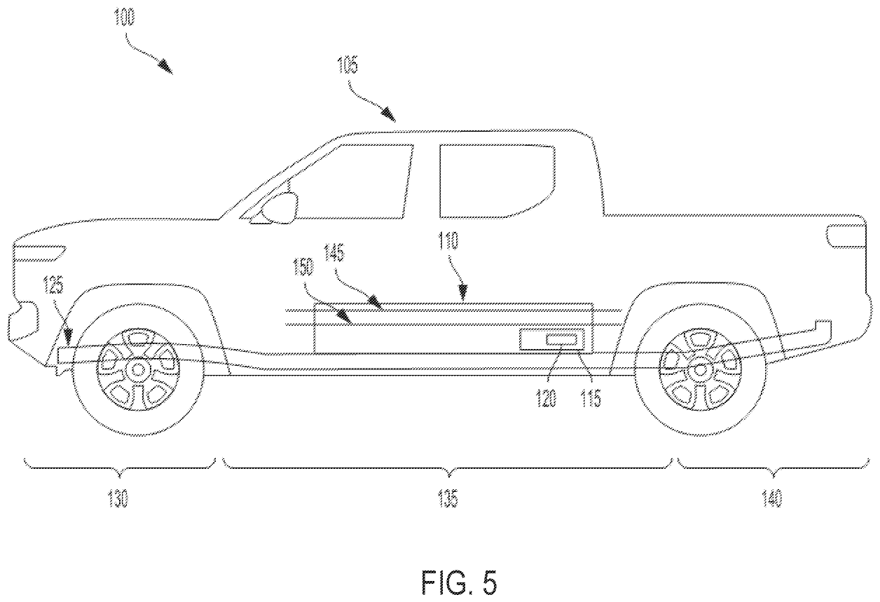

In another aspect, a plurality of battery cells as described above may be used to form a battery and/or a battery pack, that may find a wide variety of applications such as general storage, or in vehicles. By way of illustration of the use of such batteries or battery packs in an electric vehicle, FIG. 5 depicts is an example cross-sectional view 100 of an electric vehicle 105 installed with at least one battery pack 110. Electric vehicles 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 110 can also be used as an energy storage system to power a building, such as a residential home or commercial building. Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 110, battery modules 115, or battery cells 120 to power the electric vehicles. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the battery modules 115 or the battery cells 120 with other electrical components of the electric vehicle 105 to provide electrical power to various systems or components of the electric vehicle 105.

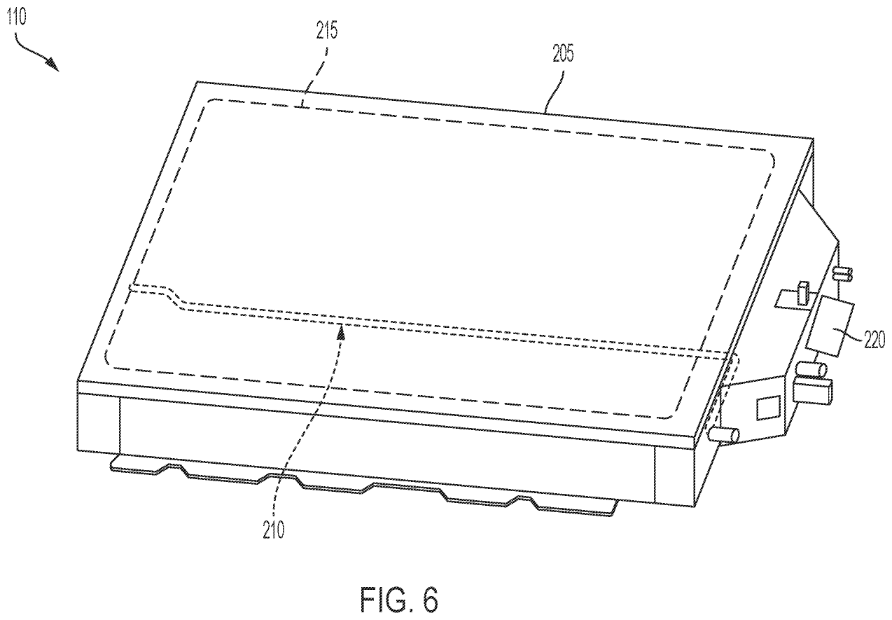

FIG. 6 depicts an example battery pack 110. Referring to FIG. 6, among others, the battery pack 110 can provide power to electric vehicle 105. Battery packs 110 can include any arrangement or network of electrical, electronic, mechanical, or electromechanical devices to power a vehicle of any type, such as the electric vehicle 105. The battery pack 110 can include at least one housing 205. The housing 205 can include at least one battery module 115 or at least one battery cell 120, as well as other battery pack components. The housing 205 can include a shield on the bottom or underneath the battery module 115 to protect the battery module 115 from external conditions, for example if the electric vehicle 105 is driven over rough terrains (e.g., off-road, trenches, rocks, etc.) The battery pack 110 can include at least one cooling line 210 that can distribute fluid through the battery pack 110 as part of a thermal/temperature control or heat exchange system that can also include at least one cold plate 215. The cold plate 215 can be positioned in relation to a top submodule and a bottom submodule, such as in between the top and bottom submodules, among other possibilities. The battery pack 110 can include any number of cold plates 215. For example, there can be one or more cold plates 215 per battery pack 110, or per battery module 115. At least one cooling line 210 can be coupled with, part of, or independent from the cold plate 215.

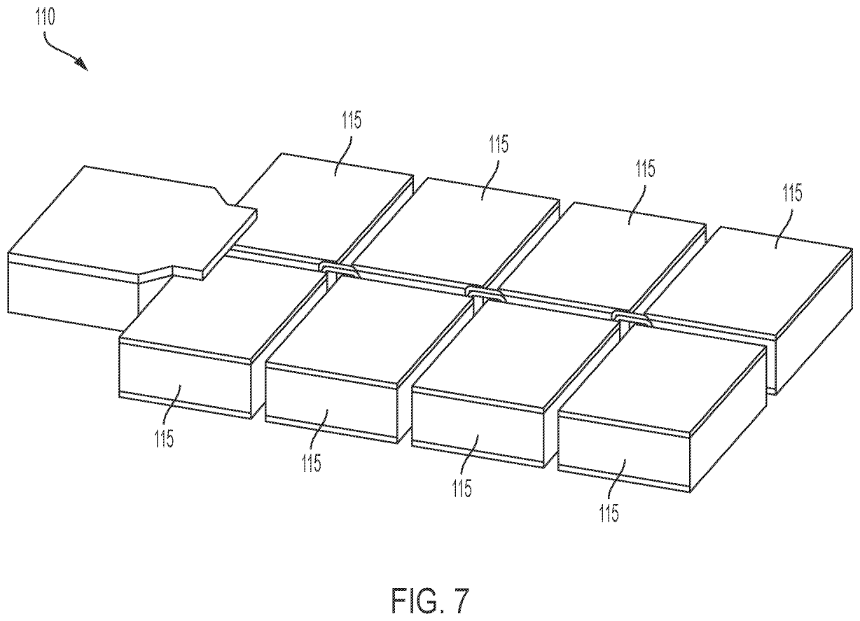

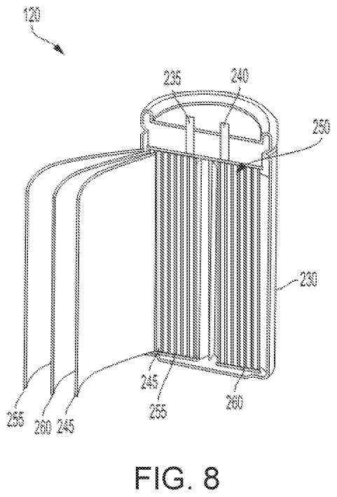

FIG. 7 depicts example battery modules 115, and FIG. 8 depicts an illustrative cross sectional view of a battery cell 120. The battery modules 115 can include at least one submodule. For example, the battery modules 115 can include at least one first (e.g., top) submodule 220 or at least one second (e.g., bottom) submodule 225. At least one cold plate 215 can be disposed between the top submodule 220 and the bottom submodule 225. For example, one cold plate 215 can be configured for heat exchange with one battery module 115. The cold plate 215 can be disposed or thermally coupled between the top submodule 220 and the bottom submodule 225. One cold plate 215 can also be thermally coupled with more than one battery module 115 (or more than two submodules 220, 225). The battery submodules 220, 225 can collectively form one battery module 115. In some examples each submodule 220, 225 can be considered as a complete battery module 115, rather than a submodule.

The battery modules 115 can each include a plurality of battery cells 120. The battery modules 115 can be disposed within the housing 205 of the battery pack 110. The battery modules 115 can include battery cells 120 that are cylindrical cells or prismatic cells, for example. The battery module 115 can operate as a modular unit of battery cells 120. For example, a battery module 115 can collect current or electrical power from the battery cells 120 that are included in the battery module 115 and can provide the current or electrical power as output from the battery pack 110. The battery pack 110 can include any number of battery modules 115. For example, the battery pack can have one, two, three, four, five, six, seven, eight, nine, ten, eleven, twelve or other number of battery modules 115 disposed in the housing 205. It should also be noted that each battery module 115 may include a top submodule 220 and a bottom submodule 225, possibly with a cold plate 215 in between the top submodule 220 and the bottom submodule 225. The battery pack 110 can include or define a plurality of areas for positioning of the battery module 115. The battery modules 115 can be square, rectangular, circular, triangular, symmetrical, or asymmetrical. In some examples, battery modules 115 may be different shapes, such that some battery modules 115 are rectangular but other battery modules 115 are square shaped, among other possibilities. The battery module 115 can include or define a plurality of slots, holders, or containers for a plurality of battery cells 120.

Battery cells 120 have a variety of form factors, shapes, or sizes. For example, battery cells 120 can have a cylindrical, rectangular, square, cubic, flat, or prismatic form factor. Battery cells 120 can be assembled, for example, by inserting a winded or stacked electrode roll (e.g., a jelly roll) including electrolyte material into at least one battery cell housing 230. The electrolyte material, e.g., an ionically conductive fluid or other material, can generate or provide electric power for the battery cell 120. A first portion of the electrolyte material can have a first polarity, and a second portion of the electrolyte material can have a second polarity. The housing 230 can be of various shapes, including cylindrical or rectangular, for example. Electrical connections can be made between the electrolyte material and components of the battery cell 120. For example, electrical connections with at least some of the electrolyte material can be formed at two points or areas of the battery cell 120, for example to form a first polarity terminal 235 (e.g., a positive or anode terminal) and a second polarity terminal 240 (e.g., a negative or cathode terminal). The polarity terminals can be made from electrically conductive materials to carry electrical current from the battery cell 120 to an electrical load, such as a component or system of the electric vehicle 105.

The battery cell 120 can be included in battery modules 115 or battery packs 110 to power components of the electric vehicle 105. The battery cell housing 230 can be disposed in the battery module 115, the battery pack 110, or a battery array installed in the electric vehicle 105. The housing 230 can be of any shape, such as cylindrical with a circular (e.g., as depicted), elliptical, or ovular base, among others. The shape of the housing 230 can also be prismatic with a polygonal base, such as a triangle, a square, a rectangle, a pentagon, and a hexagon, among others.

The housing 230 of the battery cell 120 can include one or more materials with various electrical conductivity or thermal conductivity, or a combination thereof. The electrically conductive and thermally conductive material for the housing 230 of the battery cell 120 can include a metallic material, such as aluminum, an aluminum alloy with copper, silicon, tin, magnesium, manganese, or zinc (e.g., aluminum 1000, 4000, or 5000 series), iron, an iron-carbon alloy (e.g., steel), silver, nickel, copper, and a copper alloy, among others. The electrically insulative and thermally conductive material for the housing 230 of the battery cell 120 can include a ceramic material (e.g., silicon nitride, silicon carbide, titanium carbide, zirconium dioxide, beryllium oxide, and among others) and a thermoplastic material (e.g., polyethylene, polypropylene, polystyrene, polyvinyl chloride, or nylon), among others.

The battery cell 120 can include at least one anode layer 245, which can be disposed within the cavity 250 defined by the housing 230. The anode layer 245 can receive electrical current into the battery cell 120 and output electrons during the operation of the battery cell 120 (e.g., charging or discharging of the battery cell 120). The anode layer 245 can include an active substance.

The battery cell 120 can include at least one cathode layer 255 (e.g., a composite cathode layer compound cathode layer, a compound cathode, a composite cathode, or a cathode). The cathode layer 255 can be disposed within the cavity 250. The cathode layer 255 can output electrical current out from the battery cell 120 and can receive electrons during the discharging of the battery cell 120. The cathode layer 255 can also release lithium ions during the discharging of the battery cell 120. Conversely, the cathode layer 255 can receive electrical current into the battery cell 120 and can output electrons during the charging of the battery cell 120. The cathode layer 255 can receive lithium ions during the charging of the battery cell 120.

The battery cell 120 can include an electrolyte layer 260 disposed within the cavity 250. The electrolyte layer 260 can be arranged between the anode layer 245 and the cathode layer 255 to separate the anode layer 245 and the cathode layer 255. The electrolyte layer 260 can transfer ions between the anode layer 245 and the cathode layer 255. The electrolyte layer 260 can transfer cations from the anode layer 245 to the cathode layer 255 during the operation of the battery cell 120. The electrolyte layer 260 can transfer cations (e.g., lithium ions) from the cathode layer 255 to the anode layer 245 during the operation of the battery cell 120.

The present invention, thus generally described, will be understood more readily by reference to the following examples, which are provided by way of illustration and are not intended to be limiting of the present invention.

### EXAMPLES

General. First-principles density functional theory (DFT) methodologies were used to model the stability of the Li₃PS₄ electrolyte-Li metal interface in the presence of various thermodynamically stable and/or metastable polyanionic lithium metal oxide compounds as coatings. In particular, the interface app in materialproject.org, an open access materials database that is open to public was used to conduct the analysis.

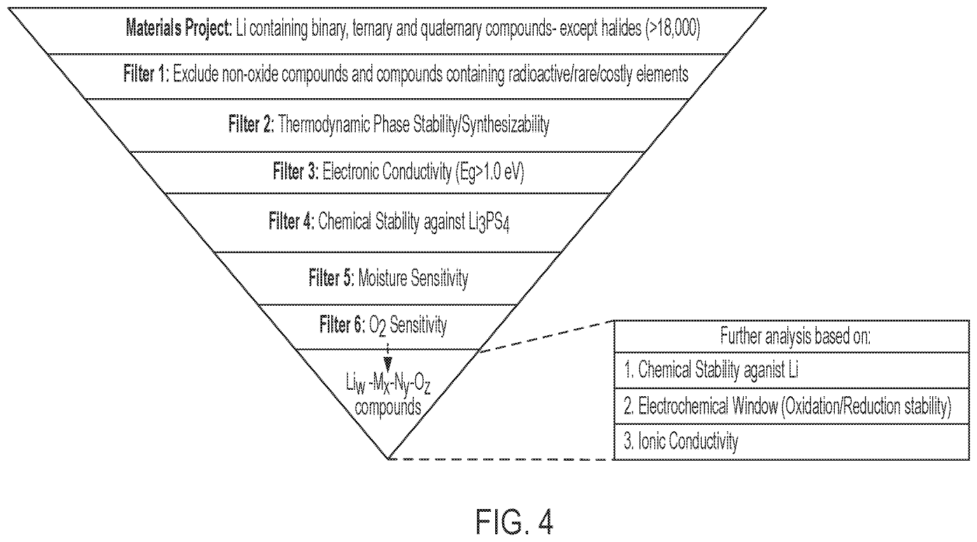

Our screening strategy (see FIG. 4) employed following criteria to identify potential Li metal anode coating materials for Li₃PS₄-based solid-state batteries: (a) lithium content (b) stability/synthesizability, (c) electronic insulation, (d) equilibrium with the sulfide electrolyte (Li₃PS₄) (e) equilibrium/no reaction with moisture and (f) equilibrium/no reaction with air. Additionally, we discard all compounds with radioactive, toxic, costly, and rare elements (e.g., Pm, Po, At, Rn, Fr, Ra, Ac, Th, Pa, U, Np, Pu, Am, Cm, and Bk) to ensure mass synthesizability. Halide containing compounds are also excluded, because they have in several deposition processes been replaced due to the known long-term corrosive effect of residual halide components.

Starting with >18,000 Li containing binary, ternary and quaternary compounds, a list of thermodynamically stable and/or metastable oxide compounds that are likely to be experimentally synthesized was determined. The thermodynamic stability was quantified based on the energy of the compound above the convex hull (Emu) in the chemical space of elements that make up the material and such data are readily acquired from the materials project database. A compound with Eₕᵤₗₗ=0 lies in the energy convex hull and is a thermodynamically stable phase at 0 K. A compound with Eₕᵤₗₗ>0 is thermodynamically metastable and a material with a high energy above hull (e.g., >50 meV/atom) may have a strong driving force to decomposition and would be difficult to synthesize experimentally. Other things such as noble metal groups (e.g., Pt, Au, etc.), halides (Cl, F, Br, and I), radioactive (e.g., Th, Rd, etc.) and toxic chemical elements (e.g., Pb, As, Cd, etc.) were excluded resulting in a list of 4238 Li containing oxide compounds that are likely to be experimentally synthesized on large scale.

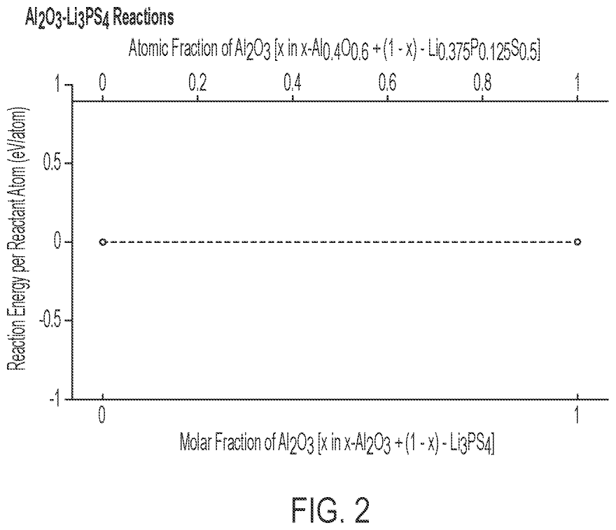

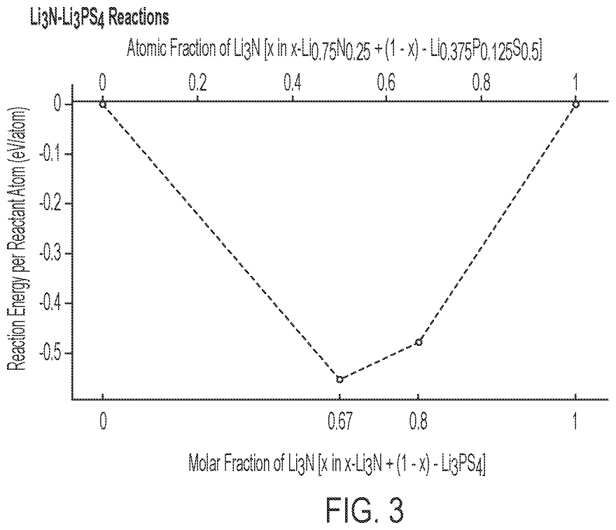

To identify coatings that are electronically insulating, compounds were screened for those that exhibit a bandgap above 1.0 eV, and several more candidates were eliminated on the basis of whether they exhibit chemical equilibrium with Li₃PS₄ electrolyte or not. To compute whether a compound exhibits equilibrium with the electrolyte, materials project uses the convex hull method. For each candidate compound, the convex hull is calculated for the set of elements defined by the compound plus the electrolyte material. Within this convex hull, tie line connecting the candidate compound with the electrolyte material is looked for. The presence of such a tie line is the indication that the candidate compound does exhibit stable equilibrium with the electrolyte. The absence of such a tie line indicates that the candidate compound does not exhibit stable equilibrium with the electrolyte but rather reacts. FIG. 2 shows the chemical reaction between Li₃PS₄ and Al₂O₃. It shows a straight line between the molar fraction x=0 to x=1 with zero reaction energy per atom (i.e., y=0 eV/atom). FIG. 2 demonstrates that if Al₂O₃ is deposited on Li anode as an interfacial coating between the anode and the electrolyte, they do not react with the Li₃PS₄ electrolyte. FIG. 3 shows the case study of utilizing Li₃N as a coating candidate. Unlike Al₂O₃, Li₃N is predicted to react with Li₃PS₄ electrolyte, where the most energetically favorable chemical reaction is as follows: 0.333 Li₃PS₄+0.667 Li₃N→1.333 Li₂S+0.333 LiPN₂ with Eᵣₓₙ of −0.553 eV/atom.

Only six Li containing oxide compounds were screened that were found to be stable with Li₃PS₄ (widely reported sulfide-based solid electrolyte) and are therefore potential as anode coating materials at the Li metal—Li₃PS₄ electrolyte interfaces. Table 1 lists the six, screened Li containing oxide compounds that exhibits chemical equilibrium with Li₃PS₄, ranked based on their band-gap energy.

TABLE 1
Chemical stability with Li₃PS₄.

| | Band Gap | | Eᵣₓₙ |
|---|---|---|---|
| Material | (eV) | Reaction with Sulfide Electrolyte | (ev/atom) |
| Li₃PO₄ | 5.8558 | Li₃PS₄ + Li₃PO₄ => No Reaction | 0 |
| | | (NR) | |
| LiMgPO₄ | 5.4297 | Li₃PS₄ + LiMgPO₄ => NR | 0 |
| LiAl(Si₂O₅)₂ | 5.3223 | Li₃PS₄ + LiAl(Si₂O₅)₂ => NR | 0 |
| LiAl₅O₈ | 5.2491 | Li₃PS₄ + LiAl₅O₈ => NR | 0 |
| LiAlSiO₄ | 4.8504 | Li₃PS₄ + LiAlSiO₄ => NR | 0 |
| Li₃Sc₂(PO₄)₃ | 4.7407 | Li₃PS₄ + Li₃Sc₂(PO₄)₃ => NR | 0 |

It is desirable that the oxide coating materials are stable against moisture and air to protect the highly reactive Li metal anode during processing and handling. Therefore, the materials were screened based on their chemical reactivity with moisture and air. Table 2 is a listing of the moisture and O₂ sensitivity of the six compounds screened. The screened Li containing oxides compounds have excellent stability against moisture and air, except for LiAl₅O₈, which is prone to react with moisture.

TABLE 2
Chemical stability against moisture and O₂.

| | Band | | | | |
|---|---|---|---|---|---|
| | Gap | Reaction with | E | Reaction with | E |
| Material | (eV) | moisture | (eV/atom) | O₂ | (eV/atom) |
| | 5.8558 | H₂O + Li₃PO₄ => | N/A | O₂ + Li₃PO₄ => | 0 |
| | | NR | | NR | |
| LiMgPO₄ | 5.4297 | H₂O + LiMgPO₄ => | N/A | O₂ + LiMgPO₄ => | 0 |
| | | NR | | NR | |
| LiAl(Si₂O₅)₂ | 5.3223 | H₂O + | N/A | O₂ + | 0 |
| | | LiAl(Si₂O₅)₂ > | | LiAl(Si₂O₅)₂ => | |
| | | No Reaction | | NR | |
| LiAl₅O₈ | 5.2491 | 0.667 H₂O + | −0.001 | O₂ + LiAl₅O₈ => | 0 |
| | | 0.333 LiAl₅O₈ => | | NR | |
| | | 0.333 LiAlO₂ + | | | |
| | | 1.333 AlHO₂ | | | |
| LiAlSiO₄ | 4.8504 | H₂O + LiAlSiO₄ => | N/A | O₂ + LiAlSiO₄ => | 0 |
| | | NR | | NR | |
| Li₃Sc₂(PO₄)₃ | 4.7407 | H₂O + | N/A | O₂ + | 0 |
| | | Li₃Sc₂(PO₄)₃ => | | Li₃Sc₂(PO₄)₃ => | |
| | | NR | | NR | |

Stability against Li metal. Five stable (i.e., experimentally synthesizable) Li containing oxide compounds were identified as being practical as a Li protective coating material. Table 3 summarizes the stability of the lithium oxide materials against Li metal. It is desirable that the coating to be in chemical equilibrium with Li metal. For example, as shown in Table 3, 0.151 Al₂O₃(conventional coating) reacts with 0.849 Li to form 0.113 Li₅AlO₂ and 0.094 Li₃Al₂ with Eᵣₓₙ of −0.220 eV/atom. The ratio between Li to Al₂O₃ is 0.849/0.151=5.623 for this reaction. In Table 3, the 5 screened Li-containing oxide compounds are shown in comparison to Al₂O₃(state-of-art coating material for Li metal anode is SSBs). For example, LiAlSiO₄ has a Li:LiAlSiO₄=6.353, and therefore 6.353/5.623=1.130 in the ‘Ratio vs Al₂O₃’ column. For Li reaction, it is beneficial if the “Ratio” value of the coating is less compared to Li-Al₂O₃ reaction ratio (i.e., the oxide coating consumes less Li). Similarly, it is desired for Eᵣₓₙ of Li vs coating material to be higher (i.e., less favorable to react with Li) compared to Li vs Al₂O₃ reaction. The compared Eᵣₓₙ of the screened oxide materials vs. Al₂O₃ is listed in the ‘Eᵣₓₙ vs Al₂O₃’ column. The two values that are referenced to Al₂O₃ for molar ratio and reaction enthalpy are then summed. Since these values are evaluated based on the molar fraction, we then convert this value by dividing my molecular weight: e.g., 2.00/101.961×1,000=19.615 for Al₂O₃. In the last column (‘Li Stability Score’), the percentage improvement is provided vs. Al₂O₃ for all materials: 19.615/18.531×100=105.8% for LiAlSiO₄. As shown in Table 3, all compounds are shown to have comparable performance for Li stability, when compared with the state-of-art Al₂O₃ material. However, three of the five compounds have improved performance compared to Al₂O₃:LiAl(Si₂O₅)₂, Li₃Sc₂(PO₄)₃, and LiAlSiO₄.

TABLE 3
Chemical stability with Li metal.

| | | | Ratio | | | |
|---|---|---|---|---|---|---|
| | | | vs | Eᵣₓₙ | Eᵣₓₙ vs | Li Stability |
| Compound | Reaction with Li | Ratio | Al₂O₃ | (ev/atom) | Al₂O₃ | Score |
| Al₂O₃ | 0.849 Li + 0.151 | 5.623 | 1 | −0.220 | 1 | 100.00 |
| | Al₂O₃ => 0.094 | | | | | |
| | Li₃Al₂ + 0.113 | | | | | |
| | Li₅AlO₄ | | | | | |
| Li₃PO₄ | 0.889 Li + 0.111 | 8.009 | 1.424 | −0.344 | 1.564 | 76.014 |
| | Li₃PO₄ => 0.444 | | | | | |
| | Li₂O + 0.111 Li₃P | | | | | |
| LiMgPO₄ | 0.889 Li + 0.111 | 8.009 | 1.424 | −0.453 | 2.059 | 71.073 |
| | LiMgPO₄ => 0.333 | | | | | |
| | Li₂O + 0.111 Li₃P + | | | | | |
| | 0.111 MgO | | | | | |
| LiAl(Si₂O₅)₂ | 0.909 Li + 0.091 | 9.989 | 1.776 | −0.37 | 1.682 | 173.709 |
| | LiAl(Si₂O₅)₂ => | | | | | |
| | 0.091 Li₅AlO₄ + | | | | | |
| | 0.136 Li₄SiO₄ + | | | | | |
| | 0.227 Si | | | | | |
| LiAlSiO₄ | 0.864 Li + 0.136 | 6.353 | 1.130 | −0.265 | 1.205 | 105.879 |
| | LiAlSiO₄ => 0.136 | | | | | |
| | Li₅AlO₄ + 0.045 | | | | | |
| | Li₇Si₃ | | | | | |
| Li₃Sc₂(PO₄)₃ | 0.96 Li + 0.04 | 24 | 4.268 | −0.501 | 2.277 | 118.566 |
| | Li3Sc₂(PO₄)₃ => | | | | | |
| | 0.12 Li₃P + 0.08 | | | | | |
| | LiScO₂ + 0.32 Li₂O | | | | | |

Analysis based on Electrochemical Performance: Ionic Conductivity and Electrochemical Window. The interfacial coating layer needs to be ionically conductive under operating condition to reduce the interfacial resistance and the cell overpotential. Usually, compounds containing lithium sub-lattices enable better lithium diffusivity than binary metal oxides. Therefore, the Li containing oxide compounds screened in this work, are expected to have better ionic conductivity compared to the state-of-art binary oxide coatings (e.g., Al₂O₃). A machine learning model (“ML;” see Sendek et al., Energy Environ. Sci., 2017, 10, 306-320 for the data used to train the model) was used to predict the ionic conductivity of the compounds. The rank of the screened oxide compounds based on their predicted ionic conductivity is shown in Table 4.

TABLE 4
Predicted Ionic Conductivity of screened oxide coatings

| Compounds | log(ionic conductivity, Scm⁻¹) |
|---|---|
| Li₃Sc₂(PO₄)₃ | −7.1 |
| LiAl(Si₂O₅)₂ | −7.7 |
| LiMgPO₄ | −8.9 |
| Li₃PO₄ | −10.2 |
| LiAlSiO₄ | −12.8 |

An ideal anode-electrolyte interfacial coating material should also exhibit a wide electrochemical window that spans the anode operating voltage and overlaps with the electrochemical window of the electrolyte (electrochemical stability). The electrochemical stability window of a material, basically, is the voltage range (versus Li metal) in which the material is stable against decomposition by either Li consumption or release. Table 5 ranks the screened oxides, based on the width of their electrochemical stability window. The screened oxide compounds seem to have wide electrochemical window width with oxidation potentials>4 V and reduction potentials closer to 1V. Given that the redox limits for sulfide electrolytes is typically close to 2.0 V, most of the screened oxide coatings should be compatible with Li₃PS₄ electrolyte under operating conditions, because they have oxidation potentials significantly above 2.1 V.

TABLE 5
Electrochemical Performance for screened oxide coatings

| Compounds | Oxidation potential | Window width |
|---|---|---|
| Li₃PO₄ | 4.200626 | 3.513443 |
| LiAlSiO₄ | 4.077191 | 2.97575 |
| LiAl(Si₂O₅)₂ | 4.103007 | 2.792539 |
| LiMgPO₄ | 4.24432 | 2.668795 |
| Li₃Sc₂(PO₄)₃ | 4.254221 | 2.423194 |

Polyanionic oxide compounds, such as LiAl(Si₂O₅)₂, LiMgPO₄, LiAlSiO₄, Li₃Sc₂(PO₄)₃ or a mixture of any two or more thereof, which contain a series of tetrahedron anion units of (EO₄)ⁿ⁻ or their derivatives (E_{y}O_{2y+1})ⁿ⁻where, E=P or Si, have the best qualities (wide band gap, synthesizability or phase stability, and stability against Li₃PS₄ electrolyte, moisture and air) of being a protective Li anode coating at the anode-electrolyte interface in solid-state batteries with Li₃PS₄ electrolytes. LiAl(Si₂O₅)₂ also have the best combination of stability against Li anode, predicted ionic conductivity, and electrochemical performance width and therefore is our 1^{st} tier candidate. Although LiAlSiO₄ ranks lower in ionic conductivity compared to the other screened oxides, it has strong stability against Li metal and excellent electrochemical window width. Likewise, Li₃Sc₂(PO₄)₃ ranks lower in electrochemical window width compared to the other screened compounds, but has good predicted ionic conductivity and stability against Li metal.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, or compositions, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. An electrochemical cell comprising:
a solid-state electrolyte;
an anode; and
a lithium polyanionic oxide;
wherein the lithium polyanionic oxide is at least partially deposited on a surface of the anode.

2. The electrochemical cell of claim 1, wherein the lithium polyanionic oxide comprises a band gap energy of greater than 1 eV.

3. The electrochemical cell of claim 1, wherein the lithium polyanionic oxide comprises an ionic conductivy of greater than 10⁻⁸ S/cm.

4. The electrochemical cell of claim 1, wherein the lithium polyanionic oxide comprises a energy of less than 50 meV/atom greater than the convex hull.

5. The electrochemical cell of claim 1, wherein the lithium polyanionic oxide has an E_{Hull} equal to about 0.

6. The electrochemical cell of claim 1, wherein the lithium polyanionic oxide is LiAl(Si₂O₅)₂, LiAlSiO₄, Li₃Sc₂(PO₄)₃, LiMgPO₄, Li₂PO₄, or a mixture of any two or more thereof.

7. The electrochemical cell of claim 1, wherein the lithium polyanionic oxide is LiAl(Si₂O₅)₂.

8. The electrochemical cell of claim 1, wherein the solid-state electrolyte comprises Li₃PS₄, Li₇P₃S₁₁, or Li₂SP₂S₅, or Li₆PS₅Cl.

9. The electrochemical cell of claim 1, further comprising a cathode including an electroactive material comprising a lithium nickel manganese cobalt oxide (LiNMC), a lithium iron phosphate (LFP), or a lithium cobalt oxide (LCO).

10. A solid-state battery comprising:
a cathode;
a solid-state electrolyte;
an anode; and
a lithium polyanionic oxide;
wherein the lithium polyanionic oxide forms an interfacial layer between the anode current collector and the solid state electrolyte.

11. The solid-state battery of claim 10, wherein the lithium polyanionic oxide comprises a band gap energy of greater than 1 eV.

12. The solid-state battery of claim 10, wherein the lithium polyanionic oxide comprises an ionic conductivy of greater than 10⁻⁸ S/cm.

13. The solid-state battery of claim 10, wherein the anode comprises a copper current collector, and wherein an in-situ lithium metal anode is formed during a charging cycle on the anode current collector.

14. The solid-state battery of claim 10, wherein the anode comprises a copper foil, a lithium metal foil, a silicon active material, a carbon active material, or a combination thereof.

15. The solid-state battery of claim 10, wherein the lithium polyanionic oxide comprises a energy of less than 50 meV/atom greater than the convex hull.

16. The solid-state battery of claim 10, wherein the lithium polyanionic oxide has an E_{Hull} equal to about 0.

17. The solid-state battery of claim 10, wherein the lithium polyanionic oxide is LiAl(Si₂O₅)₂, LiAlSiO₄, Li₃Sc₂(PO₄)₃, LiMgPO₄, Li₂PO₄, or a mixture of any two or more thereof.

18. The solid-state battery of claim 10, wherein the lithium polyanionic oxide is LiAl(Si₂O₅)₂.

19. The solid-state battery of claim 10, wherein the solid-state electrolyte comprises Li₃PS₄, Li₇P₃S₁₁, or Li₂SP₂S₅, or Li₆PS₅Cl.

20. The solid-state battery of claim 10, wherein the cathode comprises a lithium nickel manganese cobalt oxide (LiNMC), a lithium iron phosphate (LFP), or a lithium cobalt oxide (LCO).
